(19) United States
(12) Patent Application Publication
(10) Pub. No.: US 2013/0199203 A1
(43) Pub. Date: Aug. 8, 2013

(54) Linear Detonation Wave Diverter

(71) Applicant: FIRESTAR ENGINEERING, LLC, Mojave, CA (US)

(72) Inventors: Gregory S. Mungas, Mojave, CA (US); Gregory H. Peters, Palmdale, CA (US); Andrew T. Bingham, Mojave, CA (US)

(73) Assignee: FIRESTAR ENGINEERING, LLC, Mojave, CA (US)

(21) Appl. No.: 13/652,201

(22) Filed: Oct. 15, 2012

Related U.S. Application Data
(60) Provisional application No. 61/547,517, filed on Oct. 14, 2011.

(51) Int. Cl. F02K 9/38

(52) U.S. Cl. CPC F02K 9/38
USPC 60/779; 60/39.091; 60/39.11

(57) ABSTRACT

The presently disclosed linear detonation wave diverter provides a structure and method for quickly and controllably venting a detonation event out of the diverter without igniting working fluid upstream of a microporous barrier within the linear detonation wave diverter. Further, the detonation wave is linearly vented out of the diverter upon the failure of a burst member, which provides a low resistance path for detonation waves to exit the detonation wave diverter.

### CROSS-REFERENCE TO RELATED APPLICATIONS

The present application claims benefit of priority to U.S. Provisional Patent Application No. 61/547,517, entitled “Linear Detonation Wave Diverter” and filed on 14 Oct. 2011, which is specifically incorporated by reference herein for all that it discloses or teaches. The present application is also related to International Patent Application No. ______, entitled “Linear Detonation Wave Diverter” and filed on 15 Oct. 2012, which is specifically incorporated by reference herein for all that it discloses or teaches as well.

### GOVERNMENT LICENSE RIGHTS

This invention was made with government support under NNX11CA36C awarded by the National Aeronautics and Space Administration (NASA). The government has certain rights in the invention.

### BACKGROUND

Power generation systems often utilize a finite stored fuel source (e.g., a fuel tank) together with a stored or ambient oxidizer source. Further, in bipropellant rocket systems, it is often desirable to store exact quantities of fuel and oxidizer so that each is exhausted simultaneously during combustion. Considerable time and effort are spent calculating the appropriate quantities of fuel and oxidizer to store on a rocket, measuring consumption of the fuel and oxidizer, and detecting when the fuel and oxidizer are spent. Therefore, some power generation systems (including rocket systems) may utilize a stored monopropellant source (or a pre-mixed bipropellant source).

A monopropellant is a single energetic fluid (liquid, gas or a combination of both and sometimes with solid particles entrained) that chemically reacts (e.g., decomposes and/or combusts) to liberate gases and heat. One or both of the gases and the heat can be used to drive other applications (e.g. rocket thrusters, gas generators, inflation bags, actuators, motors, pumps, etc). Monopropellants are typically comprised of either a single chemical or a mixture of chemicals that when combined, produce a monopropellant blend. In the monopropellant blend, the constituents may remain well mixed and effectively behave as a single energetic fluid. Many bipropellants (e.g., combinations of a fuel and oxidizer such as vaporized fuel and air) when mixed together effectively act as a monopropellant. In one example implementation, the monopropellant is stored as a liquid and decomposes into a hot gas in the presence of an appropriate catalyst, upon introduction of a high-energy spark, or upon introduction of another point source ignition mechanism. Example monopropellants include hydrazine, which is often used in spacecraft attitude control jets, and hydroxyl ammonium nitrate (HAN).

However, since monopropellants can be exothermically reactive without any input except an ignition source, an unintentional line ignition can generate combustion waves that can move very rapidly through a fluid conduit or path full of monopropellant in a reverse direction of the monopropellant fluid flow (i.e., a flashback). Monopropellants and supply systems for rocket engines and other work producing systems are subject to damage when detonation progresses upstream from a combustion chamber to and through supply lines. Such danger of a flashback from the point of ignition of the monopropellant (or other point along the monopropellant feed line) back to the monopropellant storage tank has prevented the widespread utilization of monopropellants in power generation systems.

Rocket engines, gas generators, power plants, etc., can operate with monopropellants that can have high energy densities (e.g., greater than 1 MJ/kg), high volumetric energy densities (e.g., greater than 100 J/cc), and/or rapid chemical reaction times (e.g., less than 1 ms). Such highly energetic fluids can readily produce high pressure detonation shock waves (e.g., greater than 10,000 psia and in many cases greater than 100,000 psia), high post-combusted gas pressures (e.g., greater than 10,000 psia and in many cases greater than 100,000 psia), high volumetric heat release rates (e.g., greater than 100 kW/cc), and secondary ignition mechanisms, all of which are collectively very difficult to mitigate.

Some less energetic fluids (e.g., air/fuel mixtures, low-density fuel and oxidizer mixtures, or slow-burning monopropellants) may meet some but not all of the criteria defined above. For example, a conventional energetic fluid may have a high energy density (e.g., greater than 1 MJ/kg) combined with a low fluid density (e.g., less than 0.1 g/cc) or a low energy density (e.g., less than 1 MJ/kg) combined with a high fluid density (e.g., greater than 0.1 g/cc). A flashback of the less energetic fluids described above may generate combustion wave pressure and/or post-combusted gas pressures may be substantially less than 50,000 psia or perhaps even less than 10,000 psia. Furthermore, the less energetic fluids described above may have a lower volumetric heat liberation rates of substantially less than 100 kW/cc due to low fluid density, low energy density, and/or a relatively slow chemical reaction.

Protecting against the very high pressures, and secondary ignition mechanisms generated by a flashback condition produced in a system containing an energetic fluid with a high energy density, high volumetric energy density, and/or high volumetric heat release rate is a significant technical challenge.

### SUMMARY

Implementations described and claimed herein address the foregoing problems by providing a structure and method for quickly and controllably venting a detonation event out of the diverter without igniting working fluid upstream of a microporous barrier within the linear detonation wave diverter.

More specifically, implementations described and claimed herein address the foregoing problems by providing a detonation wave diverter comprising an exothermically reactive working fluid outlet configured to permit a detonation wave to travel into the detonation wave diverter; and a burst element aligned with the working fluid outlet and configured to fail in the presence of a detonation event and permit the detonation wave to travel out of the detonation wave diverter.

Further, implementations described and claimed herein address the foregoing problems by providing a detonation wave diverter comprising an exothermically reactive working fluid outlet configured to permit a detonation wave to travel into the detonation wave diverter; and a laminated foil aligned with the working fluid outlet and configured to fail in the presence of a detonation event and permit the detonation wave to travel out of the detonation wave diverter, wherein the laminated foil further permits the working fluid to flow downstream of the laminated foil and prevents combustion from the detonation event from propagating upstream of the laminated foil.

Still further, implementations described and claimed herein address the foregoing problems by providing a method comprising permitting a detonation wave to travel into a exothermically reactive working fluid outlet of a detonation wave diverter; fracturing a burst element aligned with the working fluid outlet responsive to a detonation event; and venting the detonation wave past the fractured a burst element and out of the detonation wave diverter.

Other implementations are also described and recited herein.

### BRIEF DESCRIPTIONS OF THE DRAWINGS

FIG. 1 is a sectional view of an example monopropellant propulsion thruster using a linear detonation wave diverter.

FIG. 2 illustrates an example flowchart for use of a monopropellant or a bipropellant and a linear detonation wave diverter in a propulsion system, a working fluid production system, or an electricity generation system.

FIG. 3 illustrates a perspective view of an example linear detonation wave diverter utilizing a laminated microporous foil layer as a flame barrier and a burst member.

FIG. 4 illustrates an elevation view of an example linear detonation wave diverter utilizing a laminated microporous foil layer as a flame barrier and a burst member.

FIG. 5 illustrates an elevation sectional view of an example linear detonation wave diverter utilizing a laminated microporous foil layer as a flame barrier.

FIG. 6 illustrates an elevation sectional view of an example linear detonation wave diverter utilizing a laminated microporous foil layer as a burst member.

FIG. 7 illustrates a detail elevation sectional view of an example laminated microporous foil layer utilized as a flame barrier and a burst member.

FIG. 8 illustrates an elevation sectional view of an example linear detonation wave diverter under normal operation.

FIG. 9 illustrates an elevation sectional view of an example linear detonation wave diverter experiencing a flashback condition.

FIG. 10 illustrates a sectional plan view of an example linear detonation wave diverter main housing with acoustic wave deflection voids.

FIG. 11 is a flowchart for operating a linear detonation wave diverter.

### DETAILED DESCRIPTIONS

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

Chemically reacting monopropellants and mixed fuels and oxidizers contain constituents that liberate energy through thermal decomposition and/or combustion. In combustion reactions, the reactants are at a higher energy state than the products remaining following combustion of the reactants. However, a certain quantity of energy (i.e., activation energy) is input to release the energy stored within the chemical bonds of the reactants.

This chemical energy release is often initiated by an ignition source, which provides the activation energy for a selected monopropellant or mixed fuels and oxidizers. The ignition source is typically incorporated near an injector head and within a combustion chamber of a power generation system. Many ignition sources exist including, but not limited to, electrical sparks, catalysts (i.e., substances which lower the activation energy by providing a surface which increases a reaction's chemical kinetics), heat sources, impact loads, compression heating of the monopropellant, electrostatic charging, chemical reactions with contamination and/or feedsystem materials, hydraulic fluid pressure spikes, or any combination thereof

If the ignition source is oriented downstream (i.e., in a direction away from the fluid energy storage device) of a monopropellant or a mixture of fuel(s) and oxidizer(s), flames at the ignition source can propagate upstream (i.e., in a direction towards fluid energy storage) through the feed lines to the point where the fuel(s) and oxidizer(s) are mixed or into a monopropellant storage tank. This event, commonly denoted as a flashback, may cause catastrophic system failure (e.g., destruction of a power generation system, destruction of surrounding equipment, and/or injury or death to nearby personnel).

Flashbacks may take the form of deflagration or detonation wave propagation. Deflagration is a common form of combustion where a flame speed travels at sub-sonic speeds. Deflagration combustion waves are commonly associated with relatively low energy content and sustaining ignition mechanisms (e.g., conductive heat transfer to propellant ahead of the deflagration combustion waves, heating to the propellant's ignition point).

Detonation is a phenomenon characterized by supersonic combustion wave propagation. A temperature increase caused by a detonation shockwave due to shock compression heating provides a sustaining ignition mechanism for detonation of the propellant. Very large pressure and temperature spikes as well as strong shock waves are typically associated with detonation waves. Detonation waves contain immense power and cause large pressure increases, which can be very useful in a controlled environment or very destructive in an uncontrolled environment. Conventional flashback arresting devices designed to prevent deflagration flashbacks are often not robust enough to survive detonation flashback waves nor do they address mitigating the additional secondary ignition mechanisms of detonation waves. Until now, given the extremely high pressures, heat release rates, and challenges in fully quenching/mitigating detonation waves produced by high volumetric thermal power release rate, mitigation of detonation waves was not feasible. The linear detonation wave diverters disclosed herein are specifically configured to effectively prevent and/or control detonation waves as well as deflagration flashbacks.

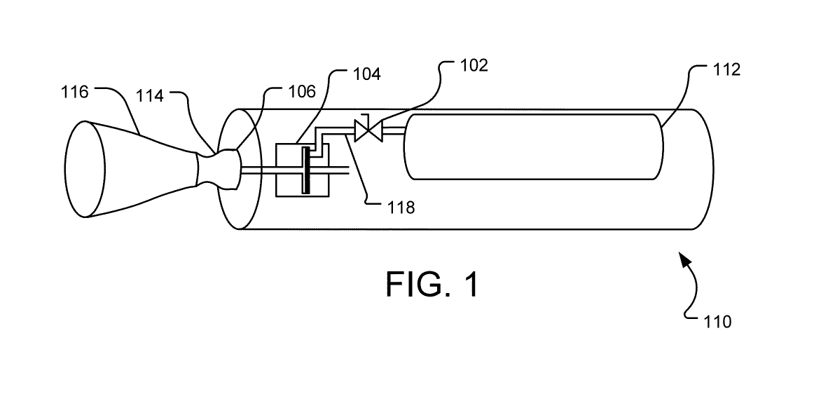

FIG. 1 is a sectional view of an example monopropellant propulsion thruster 110 using a linear detonation wave diverter 104. Propellant from a monopropellant tank 112 is fed to a combustion chamber 114 via monopropellant feed line 118. Further, the propellant from the monopropellant tank 112 passes through a flashback shut-off valve 102 and the linear detonation wave diverter 104 before reaching an ignition interface 106, where the monopropellant is controllably ignited. The combusting monopropellant feeds into an expansion nozzle 116, where it is exhausted at a high rate of speed. In the illustration, conservation of momentum principles cause the thruster 110 to be propelled from left to right.

Flashback shut-off valve 102 may shut off the fuel in the event of a flashback propagating upstream of the ignition interface 106 and downstream of the flashback shut-off valve 102. Further, the linear detonation wave diverter 104 diverts the energy caused by the flashback upstream of the ignition interface 106 and downstream of the linear detonation wave diverter 104 away from the feed line 118, flashback shut-off valve 102, and tank 112 (and other sensitive components of the thruster 110). Still further, the presence of a flashback reaching the linear detonation wave arrestor 104 may cause the flashback shut-off valve 102 to close.

The ignition interface 106 may contain a micro-fluidic porous structure of sintered metal, laminated foils, or other heat resistance materials to resist flashbacks from propagating upstream of the ignition interface 106. In one embodiment, the micro-fluidic porous structure may be made of aluminum. Further, a variable density or tiered porosity micro-fluidic media structure may be used in the micro-fluidic porous structure.

Still further, the shut-off valve 102 and/or the detonation wave diverter 104 may also contain a micro-fluidic porous structure to resist flashbacks from propagating upstream of the shut-off valve 102 and/or the detonation wave arrestor 104, respectively. While the linear detonation wave diverter 104 as shown in FIG. 1 and discussed above is implemented in a thruster 110, such the diverter 104 may also be used in other propellant and/or power generation systems as described in further detail below.

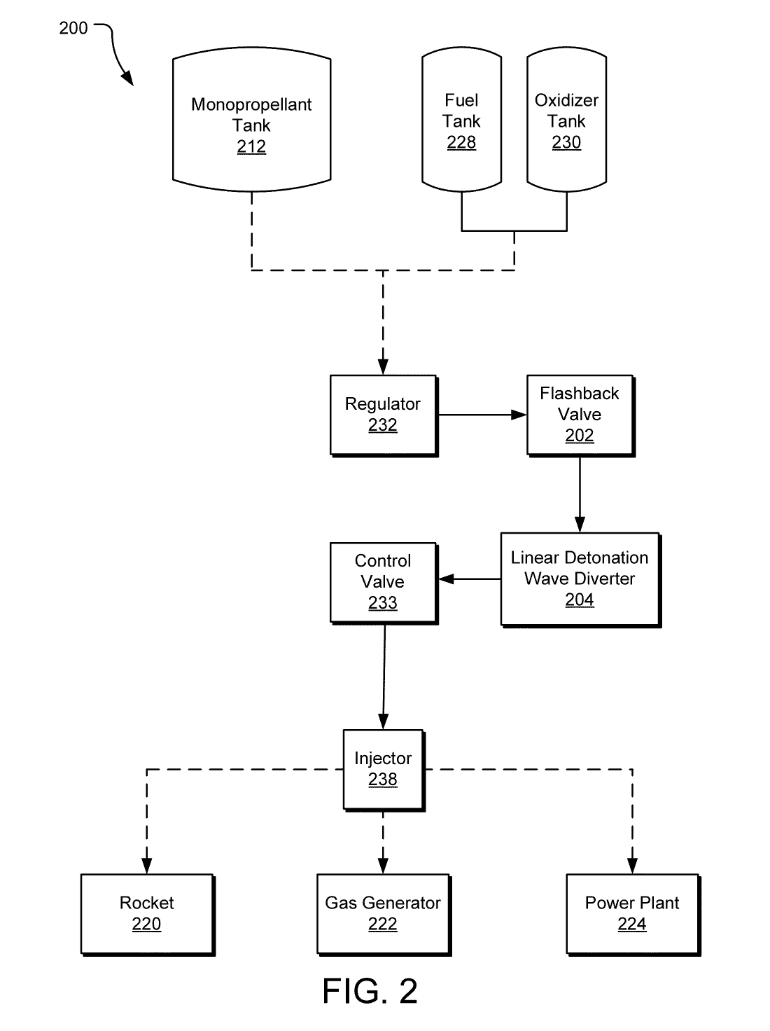

FIG. 2 illustrates an example flowchart 200 for use of a monopropellant or a bipropellant and a linear detonation wave diverter 204 in a propulsion system (e.g., rocket 220), a working fluid production system (e.g., gas generator 222), and/or an electricity generation system (e.g., power plant 224). In a first depicted implementation, a monopropellant tank 212 is the fuel/oxidizer source for a power generation system. Flashback valve 202, linear detonation wave diverter 204, and/or regulator 232 contain flashback-arresting technology as presently disclosed. The flashback arresting technology prevents or stops detonation waves from propagating upstream and causing catastrophic system failure in monopropellant feed lines and/or the monopropellant tank 212. Further, the linear detonation wave diverter 204 may also direct detonation wave energy away from the feed lines and/or the monopropellant tank 212.

In a second depicted implementation, bipropellant tanks (i.e., fuel tank 228 and oxidizer tank 230) are premixed before injection into a power generation system. Example fuels for such a system include, without limitation, natural gas, gasoline, diesel, kerosene, ethane, ethylene, ethanol, methanol, methane, acetylene, and nitro methane. Example oxidizers for such a system include, without limitation, air, oxygen/inert gas mixtures, oxygen, nitrous oxide, and hydrogen peroxide. Fuel components can be mixed with oxidizing components in many different ratios to obtain a desired combustion reaction. In some cases, the fuel may effectively be contamination in an oxidizer feed system (e.g., O₂ or N₂O), such that flashback protection in the oxidizer feed system is desirable to protect against potential contamination of the oxidizer with fuel.

The flashback arresting technology prevents or stops detonation waves from propagating upstream toward the tanks 228, 230 and causing catastrophic system failure in feed lines downstream of where fuel is premixed with oxidizer. Further, the linear detonation wave diverter 204 may also direct detonation wave energy away from the feed lines and/or the fuel tank 228 and the oxidizer tank 230.

While FIG. 2 illustrates a monopropellant configuration utilizing a singular monopropellant tank and a bipropellant configuration utilizing a singular fuel and singular oxidizer tank, it should be understood that this basic premise could be applied to mixtures involving more than one fuel and/or oxidizer component as well as additional components that may aid in combustion process or provide desirable end results in the resultant gas plumes (e.g., inhibition of undesirable trace gas species such as NOx formation, promotion of fuel/air combustion initiation, promotion of good fuel/air mixing, and alteration of fluid species with embedded solid particles).

The monopropellant and/or mixed bipropellant is regulated via regulator 232, metered and controlled by a control valve 233, and injected via an injector 238 into a desired power generation system. While the linear detonation wave diverter 204 is depicted downstream of the regulator 232 and the flashback valve 202 and upstream of the injector 238 and control valve 233, the linear detonation wave diverter 204 may be placed anywhere within a power generation system upstream of an expected or possible flashback source. In one implementation, the linear detonation wave diverter 204 is placed as close as possible to an expected or possible flashback source to minimize the energy (and potential shrapnel) released during a flashback event.

FIG. 2 illustrates three example power generation systems (i.e., thruster 220, gas generator 222, and power plant 224). Other power generation systems are also contemplated herein. For example, various work-extracting cycles may implement the flashback arresting technology (e.g., gas turbine (Brayton) cycles, Otto cycles, diesel cycles, and constant pressure cycles). The injector 238 may also be equipped with the aforementioned flashback arresting technology that prevents or stops detonation waves from propagating upstream of the injector 238 and causing catastrophic system failure. The detonation wave diverter 204 may be implemented at any point between an ignition source and a tank storing exothermically chemically reactive fluid. In some implementations, a power generation system includes multiple linear detonation wave diverters.

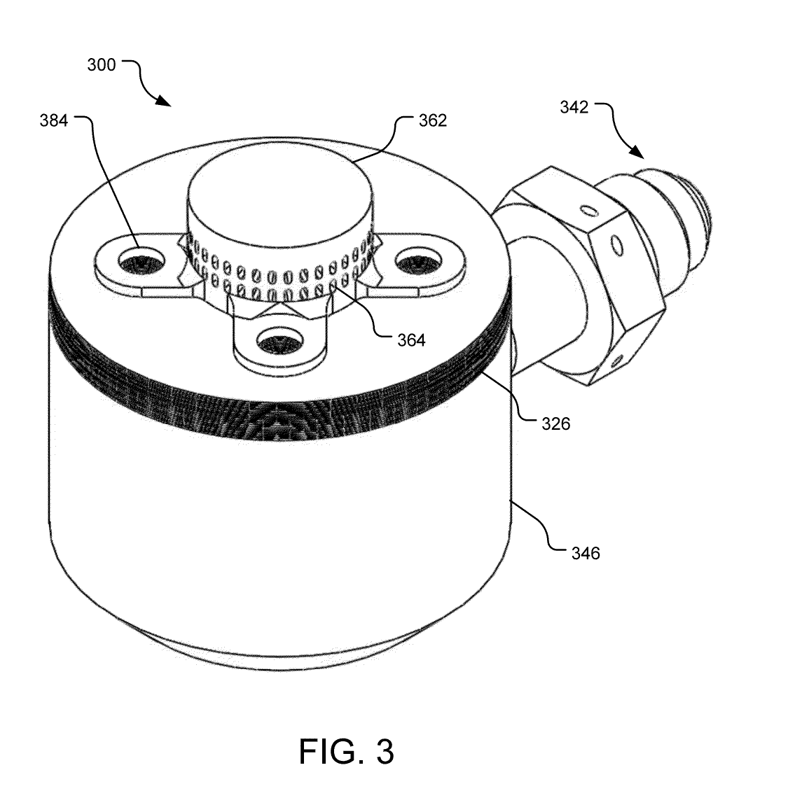

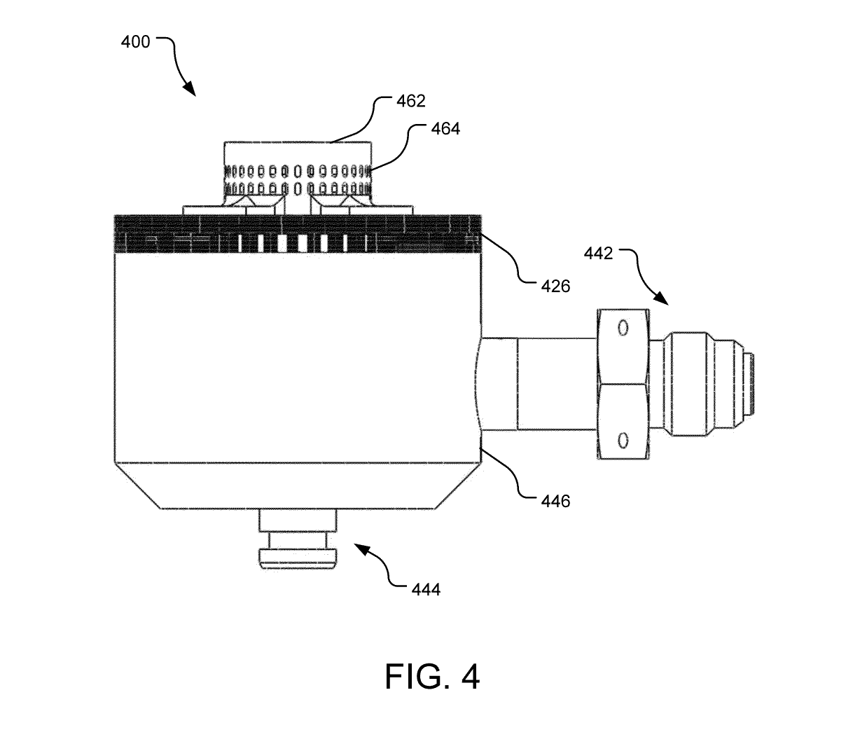

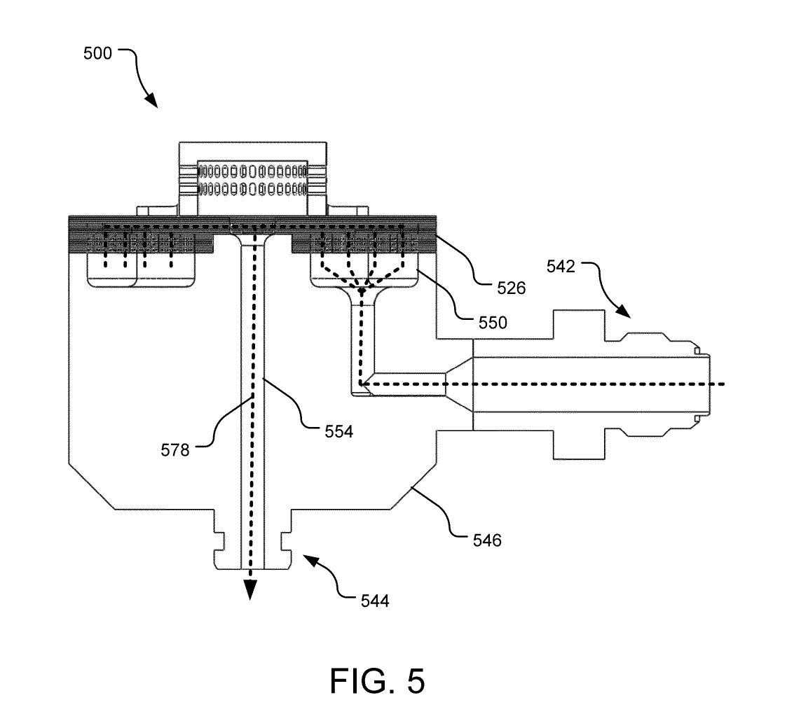

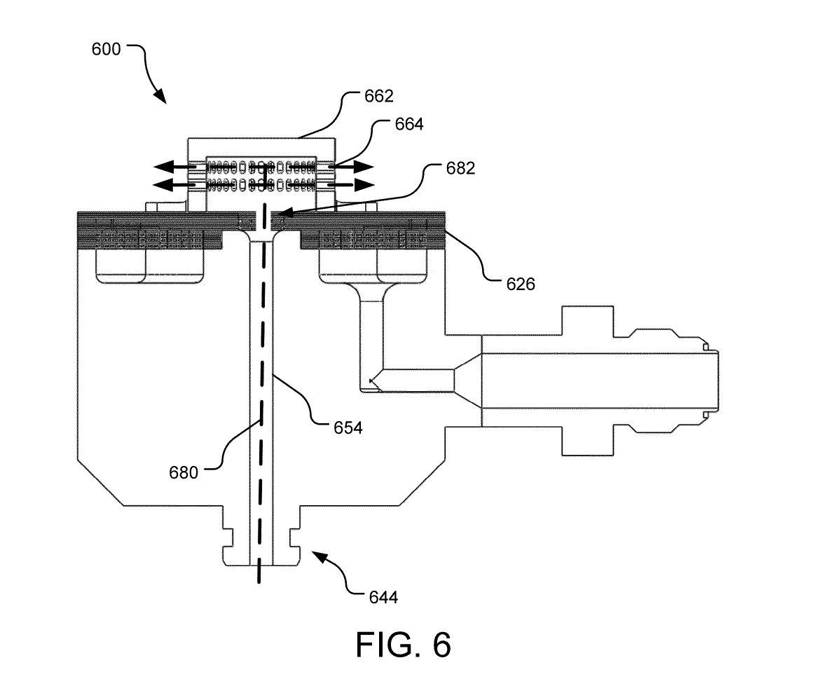

FIG. 3 illustrates a perspective view of an example linear detonation wave diverter 300 utilizing a laminated microporous foil layer 326 as a flame barrier and a burst member. The diverter 300 includes an inlet 342 for input of a working fluid (e.g., a monopropellant or a mixed bipropellant) from one or more storage tanks (not shown) into a main housing 346 of the diverter 300. During normal operation, the working fluid travels through an array of apertures or fluid passages in the laminated foil layer 326 toward a main channel (not shown, see e.g., FIGS. 5 and 6) of the diverter 300. The working fluid exits the diverter 300 via an outlet (not shown, see e.g., FIG. 4) of the main channel and then flows eventually to an ignition source when chemical energy is extracted from the working fluid.

The apertures in the laminated foil layer 326 are large enough to allow the working fluid to flow downstream, but small enough to prevent flames from a flashback from propagating upstream of the laminated foil layer 326. The laminated foil layer 326 may be made of a stack of thin metal layers (e.g., aluminum or alloys thereof) diffusion bonded, glued, brazed, welded, or merely held together under compressive force. In one implementation, bolt holes (e.g., bolt hole 384) and corresponding bolts (not shown) may be used to attach the diverter 300 to adjacent equipment. In other implementations, the bolt holes may compressively hold the laminated foil layer 326 together and securely fastened to the main housing 346 of the diverter 300.

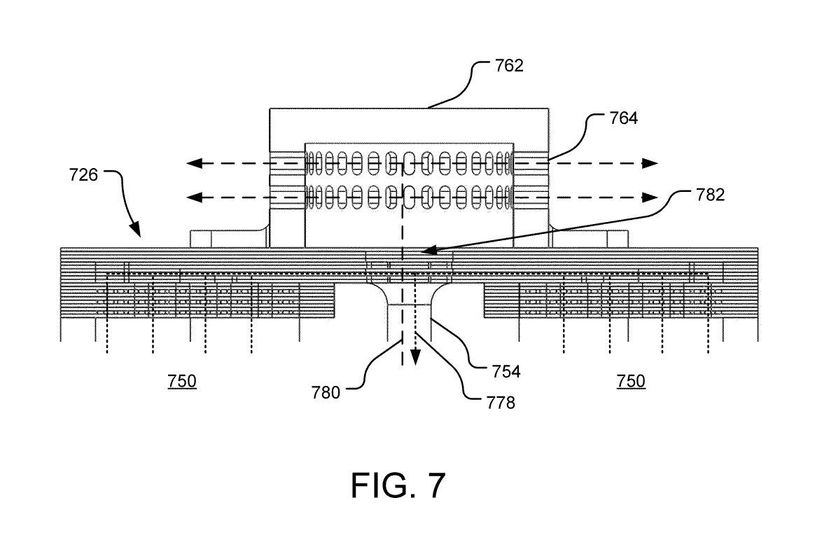

The laminated foil layer 326 further includes a thin nonporous burst area (not shown, see e.g., FIGS. 6 and 7) that during normal operation does not allow the working fluid to flow through it and out of the diverter 300 in a linear path. The strength of the nonporous burst area (i.e., material and thickness) allows the nonporous burst area to withstand the highest pressures that the linear detonation wave diverter 300 may experience during normal operation, but fracture when experiencing higher pressures that are associated with a flashback event. When a flashback event does occur, flames and/or detonation waves propagate upstream from the source of the flashback and back through the main channel. The main channel is designed to withstand pressures and excitation acoustic frequencies of the detonation waves.

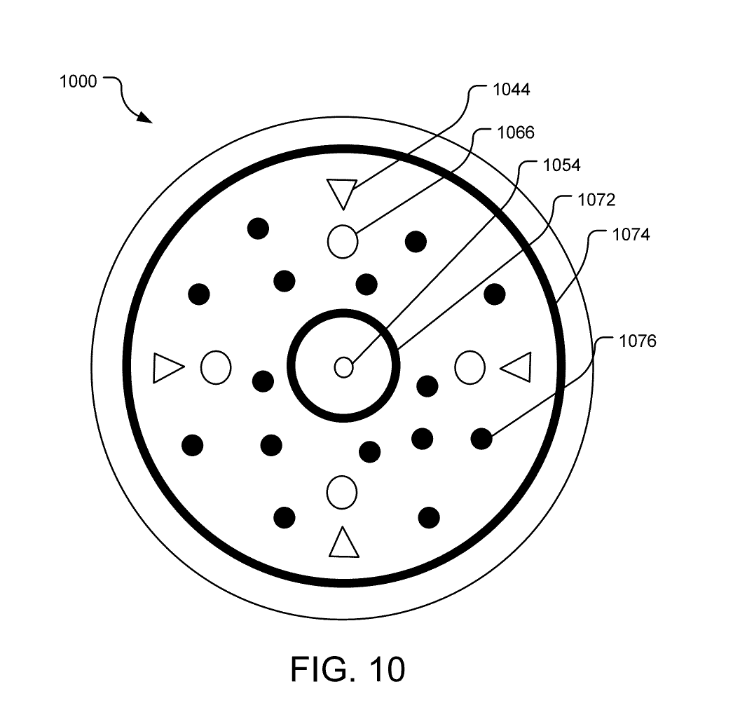

The housing 346 and laminated foil layer 326 allow acoustic waves to propagate through the main channel, but do not allow secondary sympathetic detonations to occur in unreacted working fluid passageways upstream of the laminated foil layer 326 (e.g., inlet 342). The secondary sympathetic detonations may be prevented by attenuating the amplitude of acoustic wave energy interacting with unreacted working fluid, propagating the acoustic energy of a flashback event into larger volumes, damping of the acoustic energy through energy absorbing materials, deflecting the acoustic waves around structures containing unreacted working fluid, and/or preventing resonant modes by providing anti-resonant structures within the housing 346. The anti-resonant structures (not shown, see e.g., FIG. 10) can cause destructive wave reflection, reducing the amplitude of acoustic wave energy in close proximity to working fluid upstream of the laminated foil layer 326.

Upon reaching the thin nonporous burst area of the laminated foil layer 326, energy from the detonation waves fractures the burst area, allowing the flames and/or detonation waves to further propagate linearly through the burst laminated foil layer 326. The flames and/or detonation waves then proceed out of the linear detonation wave diverter 300 via an array of detonation outlet apertures (e.g., aperture 364) in a detonation outlet cap 362. In other implementations, the outlet cap 362 is omitted or has a different geometric shape and size.

The detonation cap 362 may provide protection to the parts surrounding the linear detonation wave diverter 300 from any debris generated by the bursting of the laminated foil layer 326 and exhaust of hot combustion gasses combined with fragments of the laminated foil layer 326. Moreover, the detonation cap 362 may also used to direct the venting of the detonation wave in a more controlled fashion. The detonation cap 362 may be particularly important when the diverter 300 is used in a location where it is likely to be in close contact with sensitive components of an engine assembly or other sensitive equipment.

The flames and/or detonation waves exit the detonation outlet cap 362 in a manner that minimizes the risk of causing additional damage to the linear detonation wave diverter 300 or other components of a power generating system. Further, the linear detonation wave diverter 300 has sufficient thermal mass and a thermal heat flow path that allows the hot combusted gases to exit the linear detonation wave diverter 300 without causing the linear detonation wave diverter 300 to heat enough that any surfaces in contact with unreacted working fluid reach the ignition temperature of the unreacted working fluid and cause a secondary thermal ignition.

The pathway for the flames and/or detonation waves entering the linear detonation wave diverter 300 via the working fluid outlet and exiting the linear detonation wave diverter 300 via the burst laminated foil layer 326 is relatively linear so that the flames and/or detonation waves may proceed through and substantially out of the linear detonation wave diverter 300 relatively unimpeded. This geometry is shown and described in detail with respect to FIG. 6, for example. This minimizes the forces and stresses on the linear detonation wave diverter 300 during a flashback event by minimizing incident shock waves on the linear detonation wave diverter 300 and allowing for rapid venting of post-reacted, high pressure gases.

FIG. 4 illustrates an elevation view of an example linear detonation wave diverter 400 utilizing a laminated microporous foil layer 426 as a flame barrier and a burst member. The diverter 400 includes an inlet 442 for input of a working fluid (e.g., a monopropellant or a mixed bipropellant) from one or more storage tanks (not shown) into a main housing 446 of the diverter 400. During normal operation, the working fluid travels through an array of apertures or fluid passages in the laminated foil layer 426 toward a main channel (not shown, see e.g., FIGS. 5 and 6) of the diverter 400. The apertures in the laminated foil layer 426 are large enough to allow the working fluid to flow downstream, but small enough to prevent flames from a flashback from propagating upstream of the laminated foil layer 426. The working fluid exits the diverter 400 via an outlet 444 of the main channel and then flows eventually to an ignition source when chemical energy is extracted from the working fluid. To allow for larger flame quenching pore sizes to be used that may reduce pressure drop during nominal flowing operations, the apertures in the laminated foil layer 426 may be oriented such that under flashback conditions, the combustion wave generally travels across the apertures rather than incident to them.

The laminated foil layer 426 further includes a thin nonporous burst area (not shown, see e.g., FIGS. 6 and 7) that during normal operation does not allow the working fluid to flow through it and out of the diverter 400 in a linear path. The strength of the nonporous burst area (i.e., material and thickness) allows the nonporous burst area to withstand the highest pressures that the linear detonation wave diverter 400 may experience during normal operation, but fracture when experiencing higher pressures that are associated with a flashback event. When a flashback event does occur, flames and/or detonation waves propagate upstream from the source of the flashback and back through the main channel. The main channel is designed to withstand pressures and excitation acoustic frequencies of the detonation waves.

Upon reaching the thin nonporous burst area of the laminated foil layer 426, energy from the detonation waves fractures the burst area, removing the high pressure detonation shock wave out of the system as a sustaining ignition mechanism and allowing the post-combusted high pressure, high temperature gases, flames, and/or detonation waves to further propagate linearly through the burst laminated foil layer 426. The flames and/or detonation waves then proceed out of the linear detonation wave diverter 400 via an array of detonation outlet apertures (e.g., aperture 464) in a detonation outlet cap 462. In other implementations, the outlet cap 462 is omitted or has a different geometric shape and size.

The flames and/or detonation waves exit the detonation outlet cap 462 in a manner that minimizes the risk of causing additional damage to the linear detonation wave diverter 400 or other components of a power generating system. Further, the linear detonation wave diverter 400 has sufficient thermal mass and a thermal heat flow path that allows the hot combusted gases to exit the linear detonation wave diverter 400 without causing the linear detonation wave diverter 400 to heat enough that any surfaces in contact with unreacted working fluid reach the ignition temperature of the unreacted working fluid and cause a secondary thermal ignition.

The pathway for the flames and/or detonation waves entering the linear detonation wave diverter 400 via the working fluid outlet and exiting the linear detonation wave diverter 400 via the burst laminated foil layer 426 is relatively linear so that the flames and/or detonation waves may proceed through and out of the linear detonation wave diverter 400 relatively unimpeded. This geometry is shown and described in detail with respect to FIG. 6, for example. This minimizes the forces and stresses on the linear detonation wave diverter 400 during a flashback event by minimizing incident shock waves on the linear detonation wave diverter 400 and allowing for rapid venting of post-combusted, high pressure gases.

FIG. 5 illustrates an elevation sectional view of an example linear detonation wave diverter 500 utilizing a laminated microporous foil layer 526 as a flame barrier. Dotted lines 578 illustrate a flow path of a working fluid (e.g., a monopropellant or a mixed bipropellant) through the diverter 500 during normal operation.

The diverter 500 includes an inlet 542 for input of the working fluid from one or more storage tanks (not shown) into a main housing 546 of the diverter 500. The working fluid flows through the inlet 542 into a manifold 550 that exposes the working fluid to a porous surface of the laminated foil layer 526. Apertures in the laminated foil layer 526 are large enough to allow the working fluid to flow downstream, but small enough to prevent flames from a flashback from propagating upstream of the laminated foil layer 526. To allow for larger flame quenching pore sizes to be used that may reduce pressure drop during nominal flowing operations, the apertures in the laminated foil layer 526 may be oriented such that under flashback conditions, the combustion wave travels substantially across the laminated foil layer rather than incident on it. The working fluid travels through the array of apertures or fluid passages in the laminated foil layer 526 into a main channel 554. The working fluid flows through the main channel 554 and exits the diverter 500 via an outlet 544 of the main channel and then flows eventually to an ignition source when chemical energy is extracted from the working fluid.

FIG. 6 illustrates an elevation sectional view of an example linear detonation wave diverter 600 utilizing a laminated microporous foil layer 626 as a burst member. Dashed lines 680 illustrate a flow path of a reacting working fluid (e.g., a monopropellant or a mixed bipropellant) and associated pressure waves through the diverter 600 during a flashback event.

The laminated foil layer 626 includes a thin nonporous burst area 682 that during normal operation does not allow the working fluid to flow through it and out of the diverter 400 in a linear path (see e.g., FIG. 5). The strength of the nonporous burst area 682 (i.e., material and thickness) allows the nonporous burst area 682 to withstand the highest pressures that the linear detonation wave diverter 600 may experience during normal operation, but fracture when experiencing higher pressures that are associated with the flashback event. When the flashback event does occur, flames and/or detonation waves propagate upstream from the source of the flashback back through an outlet 644 and a main channel 654 of the diverter 600. The main channel 654 is designed to withstand pressures and excitation acoustic frequencies of the detonation waves.

Upon reaching the thin nonporous burst area 682 of the laminated foil layer 626, energy from the detonation waves fractures the burst area 682, allowing the flames and/or detonation waves to further propagate linearly through the burst laminated foil layer 626. The flames, fragments of the burst laminated foil layer 626, and/or detonation waves then proceed out of the linear detonation wave diverter 600 via an array of detonation outlet apertures (e.g., aperture 664) in a detonation outlet cap 662. In other implementations, the outlet cap 662 is omitted or has a different geometric shape and size.

The flames and/or detonation waves exit the detonation outlet cap 662 in a manner that minimizes the risk of causing additional damage to the linear detonation wave diverter 600 or other components of a power generating system. Further, the linear detonation wave diverter 600 has sufficient thermal mass and a thermal heat flow path that allows the hot combusted gases to exit the linear detonation wave diverter 600 without causing the linear detonation wave diverter 600 to heat enough that any surfaces in contact with unreacted working fluid reach the ignition temperature of the unreacted working fluid and cause a secondary thermal ignition.

The pathway for the flames and/or detonation waves entering the linear detonation wave diverter 600 via the working fluid outlet 644 and exiting the linear detonation wave diverter 600 via the burst laminated foil layer 626 is relatively linear so that the post-combustion gases, flames, and/or detonation waves may proceed through and substantially out of the linear detonation wave diverter 600 relatively unimpeded. This minimizes the forces and stresses on the linear detonation wave diverter 600 during a flashback event by minimizing incident shock waves on the linear detonation wave diverter 600 and allowing for rapid venting of post-combusted, high pressure gases.

The structure of the diverter 600 surrounding the main channel 654 is designed to ensure that even with the extremely high pressures associated with high density exothermically reactive working fluids, other than regions that are intended to fail (e.g., the burst area 682), the linear detonation wave diverter 600 remains intact throughout the flashback event. Many high density (e.g., greater than 0.1 g/cc) energetic fluids generate extremely high pressures substantially greater than 100,000 psia. While these pressures may generate stresses within the diverter 600 that exceed the allowable stresses for the materials making up the diverter 600, the diverter 600 will withstand these pressures because they rapidly subside as the burst area 682 fails.

Further, the initial temperatures of the combustion gases from a flashback event are typically very high temperature (e.g., greater than 3000 K). With a small enough main fluid channel 654 (or main channels), heat loss from the post-combusted gases quickly reduces the pressure within the channel 654 immediately after a flashback event occurs by quickly reducing the temperature of these combustion gases. For example, by quickly reducing the temperature of the combusted gases from 3000 K to 300K, the corresponding post-combusted gas pressure would reduce to approximately 10% of its initial value. The combination of rapid temperature reduction of the combustion gases and venting of the combustion gases through the burst relief can be done in a manner to prevent post-combusted gas pressures from being sustained long enough to destroy the diverter 600. This combined pressure relief, for example, may occur at a rate faster than the diverter 600 material can elastically stretch under the produced flashback pressure pulse in a manner that the diverter 600 never hits its ultimate failure stress nor absorbs sufficient strain energy that brittle fracture occurs. While localized yielding of material in the diverter 600 in close proximity to the main channel 654 may occur, the diverter 600 still remains intact and does not substantially fail.

FIG. 7 illustrates a detail elevation sectional view of a laminated microporous foil layer 726 utilized as a flame barrier and a burst member. The detail elevation sectional view of a laminated microporous foil layer 726 is a part of a linear detonation wave diverter (e.g., linear detonation wave diverters 500 and 600 of FIGS. 5 and 6, respectively). Dotted lines 778 illustrate flow paths of a working fluid (e.g., a monopropellant or a mixed bipropellant) through the microporous foil layer 726 during normal operation. Dashed lines 780 illustrate flow paths of the reacting working fluid and associated pressure waves through the microporous foil layer 726 during a flashback condition. While the microporous foil layer 726 is depicted intact, the microporous foil layer 726 will in fact be fractured during the described flashback condition (see e.g., microporous foil layer 626 of FIG. 6).

The working fluid flows from a manifold 750 and into the laminated foil layer 726. The working fluid travels through an array of apertures or fluid passages in the laminated foil layer 726 into a main channel 754. The apertures in the laminated foil layer 726 are large enough to allow the working fluid to flow downstream, but small enough to prevent flames from a flashback from propagating upstream of the laminated foil layer 726. The laminated foil layer 726 is non-porous on its exterior surfaces and in a nonporous burst area 782. Thus the working fluid flows exclusively from the manifold 750 to the main channel 754 during normal operating conditions, as illustrated by the dotted lines 778.

The strength of the nonporous burst area 782 (i.e., material and thickness) allows the nonporous burst area 782 to withstand the highest pressures that the linear detonation wave diverter may experience during normal operation, but fracture when experiencing higher pressures that are associated with a flashback event. When a flashback event does occur, flames and/or detonation waves propagate upstream from the source of the flashback through the main channel 754. The main channel 754 is designed to withstand pressures and excitation acoustic frequencies of the detonation waves.

Upon reaching the thin nonporous burst area 782 of the laminated foil layer 726, energy from the detonation waves fractures the burst area 782, allowing the flames and/or detonation waves to further propagate linearly through the burst laminated foil layer 726. Since the apertures in the laminated foil layer 726 are small enough to prevent flames from a flashback from propagating upstream of the laminated foil layer 726, the flames and/or detonation waves do not proceed upstream of the laminated foil layer 726 (e.g., into the manifold 750). The flames and/or detonation waves then proceed out via an array of detonation outlet apertures (e.g., aperture 764) in a detonation outlet cap 762, as illustrated by dashed lines 780. In other implementations, the outlet cap 762 is omitted or has a different geometric shape, size, and/or hole pattern.

The pathway for the flames and/or detonation waves moving through the linear detonation wave diverter via the main channel 754 and exiting the linear detonation wave diverter via the burst laminated foil layer 726 is relatively linear so that the flames and/or detonation waves may proceed through and substantially out of the linear detonation wave diverter relatively unimpeded. While the outlet cap 762 changes the direction of the flames and/or detonation waves, the cap is located substantially external to a main body of the linear detonation wave diverter. This minimizes the forces and stresses on the linear detonation wave diverter during a flashback event.

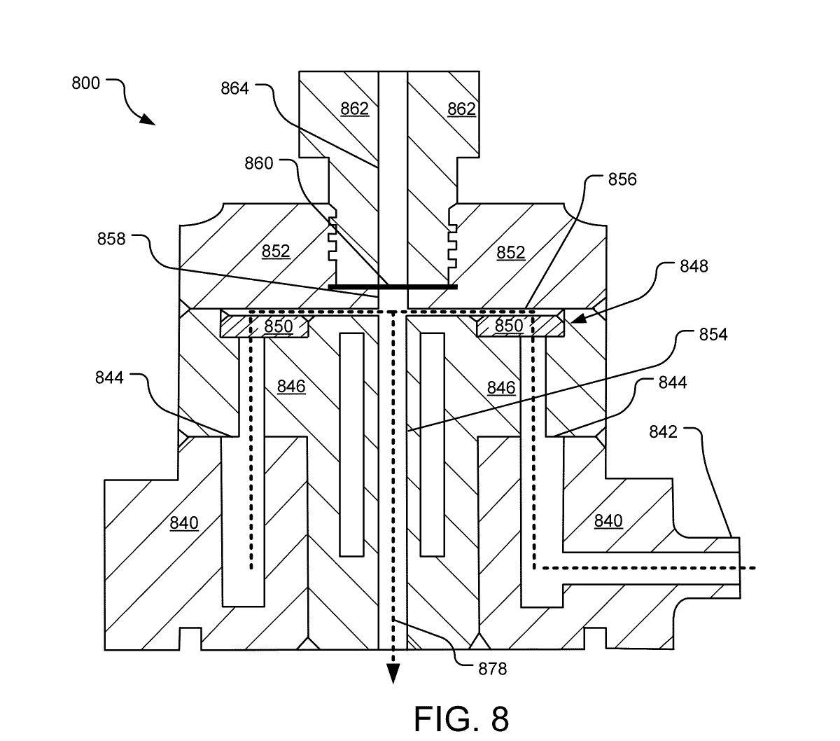

FIG. 8 illustrates an elevation sectional view of an example linear detonation wave diverter 800 under normal operation. The diverter 800 is generally cylindrical in shape with fluid paths there through as described below. Further, dotted lines 878 illustrate a flow path of an exothermically reactive working fluid (e.g., a monopropellant or a mixed bipropellant) through the diverter 800 during normal operation.

The diverter 800 includes an inlet housing 840 with an inlet 842 for input of the working fluid from one or more storage tanks (not shown). The working fluid is distributed within the inlet housing 840 and output from annular discharge 844 into a main housing 846. The main housing 846 includes an annular recess 848 with a series of apertures (not shown) that provide flow paths for the working fluid and leaves substantial material between the apertures to retain the structural integrity of the main housing 846.

A porous ring 850 fits within the recess 848 adjacent the series of apertures. The porous ring 850 has many pores (not shown) that are large enough to allow the working fluid to flow downstream, but small enough to prevent flames from a flashback from propagating upstream of the porous ring 850. The porous ring 850 may be constructed of various materials of constant, varying, or tiered porosity (e.g., sintered metal or a laminated foil stack). Other implementations include a porous ring 850 with a variety of different shapes. A burst disk housing 852 fits over the porous ring 850 and the main housing 846 and provides one or more fluid passages (e.g., passage 856) from the porous ring 850 to a main housing inner channel 854.

The fluid passage 856 may guide a secondary combustion wave initiated from the main channel 854 during a flashback event such that the combustion wave is not directly incident on the porous ring 850. Further, the fluid passage 856 may be designed to help promote heat loss from a secondary combustion wave (e.g., by minimizing the fluid passage 856 cross-sectional area and/or adding features that help promote heat transfer out of the fluid passage 856). Further, promoting heat loss from the fluid passage 856 may help relax the requirements on the pores in the porous ring 850 for quenching the secondary combustion wave incident on the porous ring 850. As a result, the porous ring 850 may utilize larger, lower pressure drop pores and still effectively stop the flashback from propagating upstream of the porous ring 850.

During normal operation of the linear detonation wave diverter 800, the working fluid flows through the inlet 842 into the inlet housing 840, through the series of apertures within the annular recess 848 of the main housing 846, and through the porous ring 850. The working fluid continues to flow from the porous ring 850 inward through the one or more fluid passages to the main housing inner channel 854 and out of the linear detonation wave diverter 800. The working fluid then flows eventually to an ignition source when chemical energy is extracted from the working fluid.

The burst disk housing 852 further includes a burst disk housing inner channel 858 and a burst disk 860. The burst disk 860 is not porous and during normal operation does not allow the working fluid to flow through it. The strength of the burst disk 860 (i.e., material and thickness) allows the burst disk 860 to withstand the highest pressures that the linear detonation wave diverter 800 may experience during normal operation, but fracture when experiencing higher pressures that are associated with a flashback event. The burst disk 860 is held in place by a burst disk retainer plug 862 with a retainer plug inner channel 864.

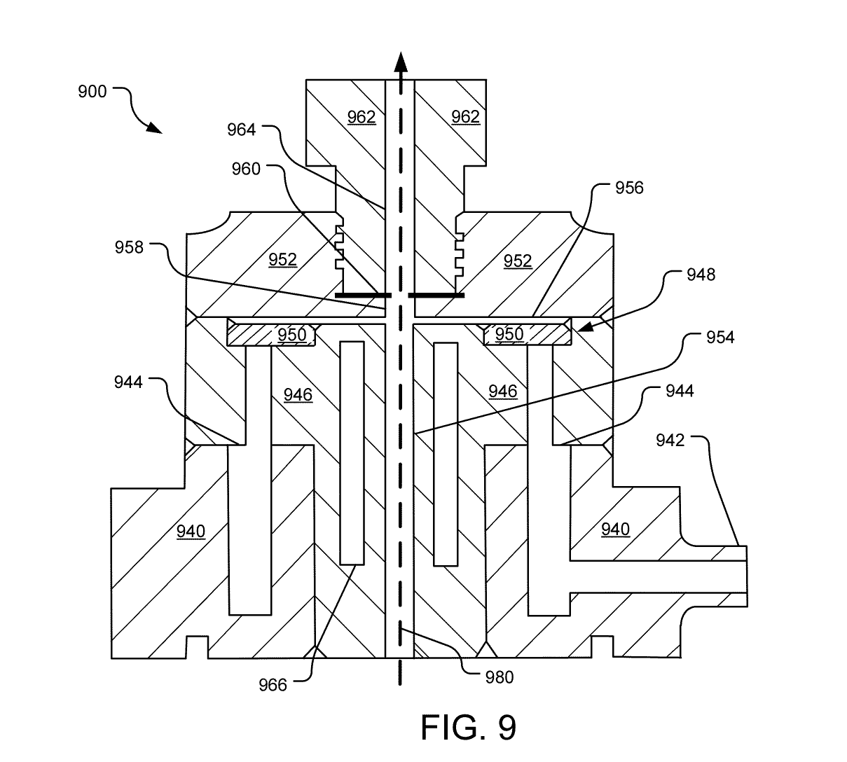

FIG. 9 illustrates an elevation sectional view of an example linear detonation wave diverter 900 experiencing a flashback condition. The diverter 900 is generally cylindrical in shape with fluid paths there through as described below. Further, dashed lines 980 illustrate a flow path of a reacting working fluid (e.g., a monopropellant or a mixed bipropellant) and associated pressure waves through the diverter 900 during a flashback condition.

The diverter 900 includes an inlet housing 940 with an inlet 942 for input of the working fluid from one or more storage tanks (not shown). The working fluid is distributed within the inlet housing 940 and output from annular discharge 944 into a main housing 946. The main housing 946 includes an annular recess 948 with a series of apertures (not shown) that provide flow paths for the working fluid and leaves substantial material between the apertures to retain the structural integrity of the main housing 946. In other implementations, the annular recess 948 is not concentric or circular. The annular recess 948 may have a variety of shapes and be at a variety of locations within the diverter 900.

A porous ring 950 fits within the recess 948 adjacent the series of apertures. The porous ring 950 has many pores (not shown) that are large enough to allow the working fluid to flow downstream, but small enough to prevent flames from a flashback from propagating upstream of the porous ring 950. A burst disk housing 952 fits over the porous ring 950 and main housing 946 and provides one or more fluid passages (e.g., passage 956) from the porous ring 950 to a main housing inner channel 954. In other implementations, the porous ring 950 is not concentric or circular. The porous ring 950 may have a variety of shapes and be at a variety of locations within the diverter 900. The porous ring 950 may be sized to provide an acceptable pressure drop through the diverter 900.

The burst disk housing 952 further includes a burst disk housing inner channel 958 and a burst disk 960. The burst disk 960 is not porous and during normal operation does not allow the working fluid to flow through it. The strength of the burst disk 960 (i.e., material and thickness) allows the burst disk 960 to withstand the highest pressures that the linear detonation wave diverter 900 may experience during normal operation, but fracture when experiencing higher pressures that are associated with a flashback event. The burst disk 960 is held in place by a burst disk retainer plug 962 with a retainer plug inner channel 964.

When the flashback event occurs, flames and/or detonation waves propagate upstream from the source of the flashback, back through the main housing inner channel 954. The pressure pulse generated in inner channel 954 excites an acoustic wave that emanates from this channel and propagates throughout the solid structure of the linear detonation wave diverter 900. This acoustic wave may have an amplitude that upon interacting with a wetted, unreacted working fluid region, may compress the energetic working fluid at a rate sufficient to initiate a secondary ignition (referred to herein as “sympathetic ignition” or “sympathetic combustion”).

The inner channel 954 is designed to withstand pressures and excitation acoustic frequencies of a detonation wave. Further, the housing 940 allows acoustic waves to propagate through the inner channel 954, but not allow secondary sympathetic detonations to occur in unreacted working fluid passageways (e.g., inlet 942) in the housing 940. The secondary sympathetic detonations are prevented by propagating the acoustic wave energy of a flashback event into larger volumes compared to the inner channel 954 and the retainer plug inner channel 964, damping of the acoustic energy through energy absorbing materials, deflecting of the acoustic waves around structures containing unreacted working fluid, and/or preventing resonant modes from occurring in close proximity to unreacted working fluid by providing anti-resonant structures within the housing 940. The anti-resonant structures can cause destructive wave reflection, reducing wave energy in close proximity to unreacted working fluid regions of the housing 940.

Acoustic energy does not propagate as readily through very low density media and/or evacuated regions. Furthermore, interfaces between regions of different wave propagation properties may readily generate interfaces that reflect acoustic waves. In one example implementation, deflection voids (e.g., void 966) may be added between each of working fluid inlet apertures and the working fluid outlet inner channel 954 to deflect acoustic wave energy around each of the working fluid inlet apertures, as further illustrated by FIG. 10 and described in further detail below. In a further implementation, the deflection voids may be filled with an acoustic dampening material.

Upon reaching the burst disk housing 952, energy from the detonation waves fractures the burst disk 960, allowing the detonation waves and/or post-combusted high pressure gases to further propagate through the burst disk housing inner channel 958 and retainer plug inner channel 964. The detonation waves and/or post-combusted high pressure gases then proceed out of the linear detonation wave diverter 900 into an area where they may dissipate without causing additional damage to the linear detonation wave diverter 900 or other components of a power generating system. The linear detonation wave diverter 900 has sufficient thermal mass and a thermal heat flow path that allows the hot combusted gases to exit the linear detonation wave diverter 900 without causing the linear detonation wave diverter 900 to heat enough that any surfaces in contact with unreacted working fluid reach the ignition temperature of the unreacted working fluid and cause a secondary thermal ignition.

The porous ring 950 prevents the flames and/or detonation waves from propagating back through the series of apertures within the annular recess 948 of the main housing 946. The substantial material between the apertures provides structural integrity of the main housing 946 and the porous ring 950 so that forces applied on the porous ring 950 and main housing 946 do not cause failure of the porous ring 950 and/or the main housing 946 and allow the flames and/or detonation waves to continue propagating upstream.

The pathway for the flames and/or detonation waves entering the linear detonation wave diverter 900 via the main housing inner channel 954 and exiting the linear detonation wave diverter 900 via the retainer plug inner channel 964 is relatively linear so that the flames and/or detonation waves may proceed through and out of the linear detonation wave diverter 900 relatively unimpeded. This minimizes the forces and stresses on the linear detonation wave diverter 900 during a flashback event by minimizing incident shock waves on the linear detonation wave diverter 900 and allowing for rapid venting of post-combusted, high pressure gases.

The following design details may apply to one or more of the implementations of a linear detonation wave diverters as depicted in FIGS. 1-9, for example. A number of screws or other mechanisms (not shown) may hold together a linear detonation wave diverter. Further, an inlet housing inner channel, an inner channel, and/or an inlet may be equipped with a variety of attachments (e.g., flanges, threads, compression fittings, etc.) to provide a path for a working fluid (i.e., gases, liquids, or a combination thereof) to flow through cavities within the linear detonation wave diverter. For example, the inlet may be connected to tubes, pipes or other mechanism designed for transporting the working fluid towards the inlet from the tanks 212, 228, 230 of FIG. 2. Similarly, the inlet housing inner channel may be designed so that it may be connected to tubes, pipes or other mechanism designed for transporting the working fluid away from the inlet housing inner channel towards the injector 238 of FIG. 2. For example, various components of the linear detonation wave diverter have threads for threading the components together and/or for screws that hold the components of the linear detonation wave diverter together. Note that while the laminated foils of FIGS. 3-7 and burst disks of FIGS. 8 and 9 are depicted as a flat structures, the laminated foils and burst disks may have various alternate geometrical structures (e.g., hemispherical and conical).

In one implementation, the linear detonation wave diverter is used in conjunction with a flashback shut-off valve (not shown). For example, the shut-off valve may be attached to the burst disk so that in the case of a flashback, the shut-off valve closes off the flow of fluid from the tank(s) 212, 228, and/or 230 to the injector 238 of FIG. 2. More specifically, the shut-off valve may close in case of a fracture and/or failure of the laminated foil and/or burst disk.

In another implementation, upon failure, the burst relief opens up an area sufficiently large to momentarily substantially increase the working fluid flow rate to the linear detonation wave diverter. This increase in flow rate through an upstream device such as a flow sensitive control valve (also known as a hydraulic fuse) may actuate an upstream valve to close upon excess fluid draw.

In yet another implementation, the linear detonation wave diverter and the flashback shut-off valve work together as a working fluid shut-off assembly for isolating a working fluid source in the event of a flashback. The laminated foil or burst disk within the linear detonation wave diverter fails in the presence of the flashback and the flashback shut-off valve is biased closed and attached to the laminated foil or burst disk. Such a shut-off valve may be held open by the laminated foil or burst disk while the laminated foil or burst disk is intact and close when the laminated foil or burst disk fails.

The flashback shut-off valve may be designed so that it has sufficient force to actuate against the highest expected pressures to be encountered within the working fluid shut-off assembly. In one implementation, closing the flashback shut-off valve stops the normal flow of the working fluid, which will quickly starve a primary source of working fluid for a potential post-detonation fire event.

In one implementation, the microfluidic laminated foil or porous ring operates as a thermal sponge that absorbs combustion energy at rates higher than the rate at which combustion waves can release combustion energy. As a result, the laminated foil or porous ring provides quenching of the combustion waves, particularly lower strength combustion waves that are not strong detonation shock waves. However, because in the normal operation, the laminated foil or porous ring is also providing a path for reactive working fluid, the effective microchannel diameter sizing and surface area of the laminated foil or porous ring are strategically chosen for each particular application based on working fluid's energy density, combustion energy release rate, mass flow rate requirements and allowable pressure drop. While the quenching distance of the laminated foil or porous ring may be sufficient to arrest a primary detonation wave, the energy release from a line flashback can cause secondary ignitions through mechanical failures and/or heat transport through solid material. This conductive heat transport can produce hot spots in direct contact with un-reacted working fluid sufficient to ignite the working fluid upstream of the linear detonation wave diverter.

The linear detonation wave diverter provides protection to the sources of working fluids from the potential harm caused by detonation waves by allowing a chemical reaction of the working fluid travelling upstream to be vented before the reaction reaches the porous ring or at least in the immediate vicinity of the porous ring.

Surrounding materials can also absorb heat energy from the combustion gases, which causes the materials to increase their temperature. As a result, in the event of flashback or a detonation wave, the same fluid passages may provide path to energy capable of causing a failure of the laminated foil or porous ring. The characteristic for a material mass to absorb or release heat for a given temperature change is commonly referred to a body's thermal mass. The thermal mass is a measure of the total energy that can be absorbed by a material per degree change in temperature. For smaller changes in a body's temperature under a given heat load, more thermal mass should be used. In most cases, the thermal mass should be capable of absorbing the bulk of energy that can be expected to interact with the linear detonation wave diverter without reaching a temperature that could cause secondary ignition of the working fluid.

In general, the volume and thermal mass of the linear detonation wave diverter should be designed such to reduce the line charge of working fluid in close proximity to sensitive elements such as the laminated foil or porous ring, where the primary detonation event or secondary heating could cause the laminated foil or porous ring to fail. To prevent heat from the detonation waves from causing a secondary ignition within linear detonation wave diverter, the thermal mass of the linear detonation wave diverter should be sufficient to be able to absorb sufficient thermal energy from the residual hot exhaust gases before they are exhausted from the linear detonation wave diverter. If insufficient heat is absorbed, a secondary ignition may occur if the temperature of a surface in contact with un-reacted working fluid is elevated high enough to cause thermal ignition. The linear detonation wave diverter has sufficient thermal mass to mitigate such secondary ignition mechanism.

The linear detonation wave diverter can be manufactured from a variety of different example materials including, ferrous metals, non-ferrous metals, refractory metals, carbon (e.g., graphite and diamond), composites (e.g., carbon fiber composites), and ceramics. Generally, any material with compressive strength and ability to absorb large impact shock energies may be used. A high thermal conductivity is also, in general, desirable in order to help absorb thermal energy rapidly disperse. In some implementations of the linear detonation wave diverter, inert coatings for a particular working fluid (e.g., MgO, Al2O3, and/or Yttria) may be applied to allow use of materials that may be catalytic with the working fluid without damaging the linear detonation wave diverter. In one implementation, the linear detonation wave diverter is manufactured from metal materials due to the general ability of more ductile materials (e.g., metals) to absorb substantial shock energy before brittle shock failure (as compared to ceramics).

Further, the laminated foil or burst disk may be manufactured out of an array of materials including, without limitation, plastics (e.g., polyethylene), metals (e.g., titanium, aluminum, and stainless steel). In another implementation of the burst disk, inert coatings for a particular working fluid (e.g., MgO, Al2O3, and/or Yttria) may be applied to allow use of materials that may be catalytic with the working fluid. In general, the laminated foil or burst disk may designed to accommodate normal feed system operating pressure (including design margin) without failing, but cleanly and reliably fail when exposed to even the weakest of anticipated detonation waves.

Still further, the porous ring may be made of a sintered-metal and designed to have multiple sufficiently small and convoluted flow paths. Similarly, the laminated foil may have multiple sufficiently small and convoluted flow paths created by the stacking of layers with offset hole locations. Such flow-paths may quench and stop any remnants of a detonation wave and the accompanying shockwaves. In another implementation, the laminated foil or porous ring has a variable density design. Yet another implementation, the laminated foil or porous ring includes different micro-channel implementations, and may be configured in different geometries, such as a cup, cone, pyramid, etc. The porous ring structure may also be tiered with varying pore diameters such that areas upstream of the regions where combustion wave mitigation occurs have larger pore diameters to help mitigate pressure drop through the linear detonation wave diverter.

Statically, the energy contained within a detonation event is sufficient to yield many, if not all known materials. Dynamically, the energy contained within the detonation event is dissipated very quickly by quenching the temperature (and as a result, reducing the pressure) of the reacting working fluid. For example, the temperature of the combusting fluid during a detonation event may be up to 3000 K. As the reaction moves upstream, the surrounding material around the inner channel rapidly absorbs the thermal energy, reducing the temperature of the reacting working fluid by at least an order of magnitude (e.g., reduced down to 300 K). As a result, the pressure within the inner channel is also reduced rapidly to a level below the yield point of the material of the linear detonation wave diverter surrounding the inner channel, before the linear detonation wave diverter yields. In order for sufficient temperature quenching to occur, the material surrounding has sufficient mass and thermal conductivity to conduct the heat away from the inner channel prior to yielding of the linear detonation wave diverter. In an implementation where the linear detonation wave diverter is a single use device, some yielding may be permitted long as the pressure within the inner channel is reduced rapidly to a level below the yield point of the material prior to complete failure of the linear detonation wave diverter.

A rapid pressure pulse associated with a flashback event in a channel may generate acoustic waves that emanate from the combustion path. These acoustic waves propagate away from the combustion source through the solid material of the linear detonation wave diverter. These acoustic waves may have sufficient amplitude at the point of interaction at a surface in contact with unreacted working fluid that these acoustic waves initiate a secondary ignition at this interaction point (referred to herein as sympathetic ignition and combustion). In one implementation, the acoustic energy from a detonation event may be expanded into a larger volume inside the linear detonation wave diverter to allow the propagating acoustic wavefront surface area to grow and attenuate the amplitude of the acoustic wave in order to reduce the likelihood of a sympathetic ignition. In another implementation, a shape of each of the series of working fluid inlet apertures within the main housing may be optimized to minimize the flux of acoustic wave momentum imparted on the working fluid inlet apertures by the acoustic wave thereby reducing the amplitude of the acoustic wave incident on a wetted working fluid surface, as described in detail below to reduce the likelihood of a sympathetic ignition.

In yet another implementation, deflection voids may be added between each of working fluid inlet apertures and the working fluid outlet inner channel to deflect/scatter acoustic wave energy around each of the working fluid inlet apertures, as described in detail below to reduce the likelihood of a sympathetic ignition. In yet another implementation, one or more energy absorbing structures may be positioned adjacent the working fluid inlet apertures and the working fluid outlet inner channel to absorb acoustic wave energy and help prevent multiple acoustic wave reflections from constructively combining into a large amplitude wave incident on one or more of the working fluid inlet aperture surfaces, as described in detail below to reduce the likelihood of a sympathetic ignition.

In designing structures to be insensitive to secondary sympathetic wave reflections that produce resonant modes inside the linear wave diverter should be considered. This analysis can be done with structural dynamics modeling software that may employ numerical techniques, such as finite element analysis to describe wave propagation in complex mechanical geometries.

FIG. 10 illustrates a sectional plan view of an example linear detonation wave diverter main housing 1000 with acoustic wave deflection voids (e.g., deflection void 1066). The main housing 1000 also contains a series of apertures (e.g., aperture 1044) that provide flow paths for incoming working fluid and an inner channel 1054 that provides a flow path for outgoing working fluid. A detonation event produces a detonation wave that flows through the inner channel 1054 and out of the main housing 1000. However, the detonation event also produces an acoustic wave that penetrates through the body of the main housing 1000. If the acoustic wave reaches the incoming working fluid apertures with sufficient amplitude incident on the working fluid, the working fluid within the incoming working fluid apertures may detonate under secondary ignition and the denotation event may continue further upstream of a corresponding detonation wave diverter (not shown) encompassing the main housing 1000. This secondary detonation may render the linear detonation wave diverter ineffective.

In order to prevent detonation of the working fluid within the incoming working fluid apertures, the amplitude of the acoustic wave is attenuated at the interface of the solid structure and the unreacted working fluid. Multiple methods may be used to reduce this incident acoustic wave amplitude including, but not limited to, minimizing the component of wave momentum incident on the unreacted working fluid interface surfaces, scattering/deflecting wave energy around the working fluid interface surfaces, absorbing wave energy in the overall diverter structure prior to the acoustic wave reaching the working fluid interface surfaces, and/or designing the linear detonation wave diverter structure that through multiple wave reflections from surfaces with different wave propagation parameters inside the diverter there is minimal resonant build-up of wave amplitude in close proximity to the working fluid interface surfaces.

For example, a triangular shape of the incoming working fluid apertures deflects some or all of the acoustic waves' momentum impinging on the incoming working fluid apertures away from the incoming working fluid apertures. Further, placing the acoustic wave deflection voids between the incoming working fluid apertures and the inner channel 1054 can scatter some or all of the acoustic wave energy away from the incoming working fluid apertures. Alone or in combination, the shape/location of the incoming working fluid apertures and the acoustic wave deflection voids may reduce the amplitude of the acoustic wave incident on the working fluid within the incoming working fluid apertures enough to prevent any sympathetic detonation of the working fluid. In a further implementation, the acoustic wave deflection voids may be filled with an acoustic dampening material to absorb acoustic wave energy and reduce the amplitude of waves interacting with the unreacted working fluid interface surfaces.

In another implementation, the incoming working fluid apertures are round in cross-section to minimize the component of acoustic wave momentum incident on the interface surfaces of the incoming working fluid apertures. The round apertures may be optimized for low pressure drop rather than minimizing interaction with acoustic waves.

In yet another implementation, the incoming working fluid apertures are oval in cross-section to minimize the component of acoustic wave momentum incident on the interface surfaces of the incoming working fluid apertures. These oval apertures may be optimized to minimize radial acoustic wave interactions.

In still another implementation, the incoming working fluid apertures are square in cross-section to minimize the component of acoustic wave momentum incident on the interface surfaces of the incoming working fluid apertures. The square-shaped apertures are another example structure that may minimize acoustic wave interaction.

Further, the main housing 1000 may incorporate an inner ring 1072 of acoustic wave dampening and/or reflecting material that attenuates wave energy from the acoustic wave source. In order to prevent sympathetic ignition of working fluid within the incoming working fluid apertures, energy of acoustic waves originating from the outgoing working fluid inner channel 1054 may be attenuated prior to reaching the incoming working fluid apertures by utilizing the inner ring 1072 of acoustic wave dampening material. The inner ring 1072 forms a ring around the outgoing working fluid inner channel 1054 to protect the incoming working fluid apertures from the acoustic waves originating from outgoing working fluid inner channel 1054. The inner ring 1072 may also be designed of sufficiently low density material or be an evacuated region (zero density does not propagate acoustic waves effectively) in order to reflect waves back towards their source. The inner ring 1072 may also be a combination of wave absorbing and reflecting media to maximize attenuation of acoustic waves emanating from the outgoing working fluid inner channel 1054. The inner ring 1072 may be a structural component of the main housing 1000 or merely an acoustic dampening or wave reflecting feature of the main housing 1000.

Still further, the main housing 1000 may incorporate an outer ring 1074 of acoustic wave dampening material. In order to prevent detonation of working fluid within the incoming working fluid apertures, energy of acoustic waves originating from outgoing working fluid inner channel 1054 may be absorbed prior to reaching the incoming working fluid apertures by outer ring 1074. The outer ring 1074 forms a ring outside the incoming working fluid apertures to reduce and/or prevent acoustic waves originating from the outgoing working fluid inner channel 1054 and reaching outer bounds of the main housing 1000 from reflecting back within the main housing 1000 and constructively combining with any other acoustic waves. The outer ring 1074 may be a structural component of the main housing 1000 or merely an acoustic dampening feature of the main housing 1000.

Further yet, the main housing 1000 may incorporate multiple inserts of acoustic wave dampening and/or scattering material (e.g., insert 1076). In order to prevent sympathetic ignition of working fluid within the incoming working fluid apertures, energy of acoustic waves originating from outgoing working fluid inner channel 1054 may be absorbed and/or scattered prior to reaching the incoming working fluid apertures by the acoustic wave dampening material 1076. The acoustic wave dampening and/or scattering material 1076 forms multiple discontinuous dampening features that may absorb and/or deflect acoustic waves to protect the incoming working fluid apertures from the acoustic waves originating from outgoing working fluid inner channel 1054. The acoustic wave dampening and/or scattering material 1076 may be a structural component of the main housing 1000 or merely an acoustic dampening and/or scattering feature of the main housing 1000.

Any one or more of the disclosed scattering and dampening features depicted and described with respect to FIG. 10 may be used to reduce the likelihood of acoustic waves triggering a sympathetic ignition of the working fluid.

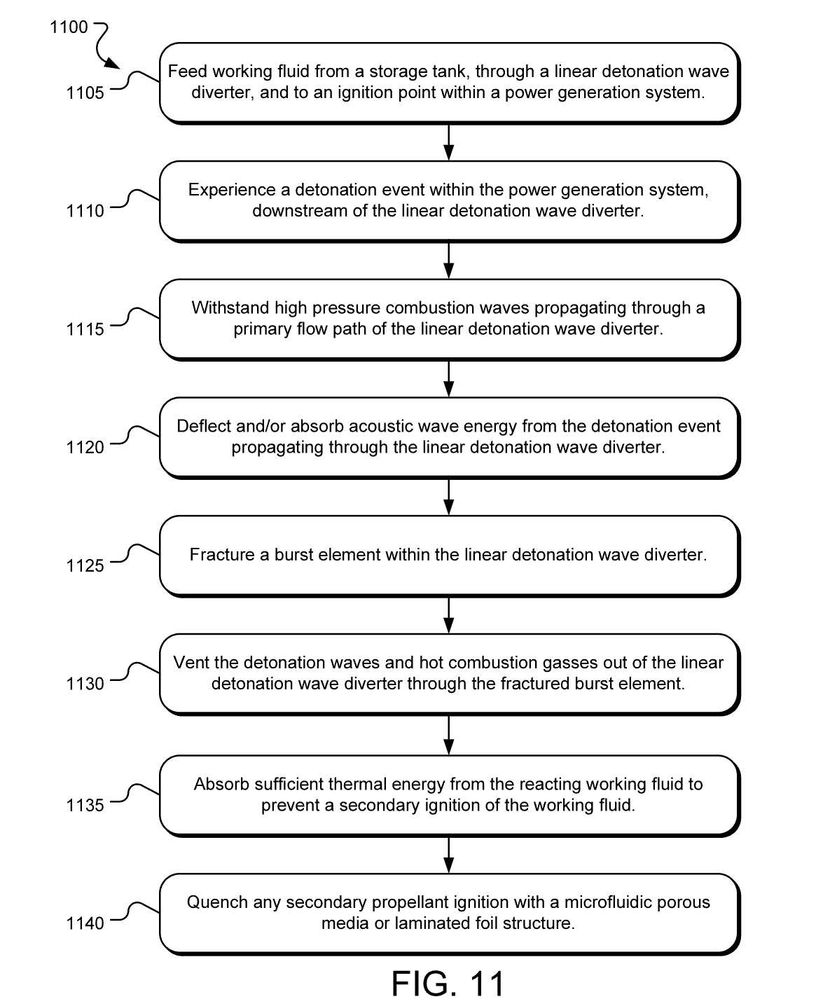

FIG. 11 is a flowchart 1100 for operating a linear detonation wave diverter. A feeding operation 1105 feeds working fluid from one or more storage tanks, through a linear detonation wave diverter, and to an ignition point within a power generation system. The power generation system may include a propulsion system, working fluid production system, and/or an electricity generation system, for example. The linear detonation wave diverter is configured to allow the working fluid to flow through it relatively unimpeded so long as the power generation system is not experiencing a detonation event.

During an experiencing operation 1110, a candidate detonation event is triggered within the power generation system, downstream of the linear detonation wave diverter. The candidate detonation event may occur if the working fluid is ignited upstream of the intended ignition point and/or ignited working fluid is allowed to travel upstream of the intended ignition point. A withstanding operation 1115 withstands high pressure combustion waves propagating through a primary flow path of the linear detonation wave diverter. The structure of the linear detonation wave diverter remains intact after the detonation event.

The candidate detonation event generates high strength combustion waves (i.e., detonation waves) that build up from exothermic energy release and propagate upstream through the exothermically reacting working fluid at a high velocity (e.g., sonic or supersonic). These detonation shock waves preheat the working fluid across the shock wave to temperatures above the working fluid's ignition temperature. The post-combusted gases behind the detonation wave are at very high temperatures (e.g., greater than 2000 K) and pressures (e.g., 30,000 psia to greater than 100,000 psia). A detonation wave provides a sustaining ignition mechanism by compression heating the working fluid above its auto-ignition temperature. The detonation wave can also do structural damage to the linear detonation wave diverter. To get rid of this detonation wave ignition mechanism and minimize structural damage to the linear detonation wave diverter, the detonation wave is guided to be released from the system in a controlled manner with minimal incident interaction of the detonation wave on the linear detonation diverter hardware.

The high pressure, high temperature post-combustion gases behind the detonation wave can do significant destructive damage even after the detonation wave is released from the system. One technique of reducing the ability of these high pressure, post-combusted gases detonation waves to destroy equipment in their path is to absorb thermal energy of the post-combusted working fluid into surrounding mass of the linear detonation wave diverter. This may dramatically reduce the temperature and pressure of these post-combusted gases behind the detonation wave.

A deflecting and/or absorbing operation 1120 deflects and/or absorbs acoustic wave momentum/energy from the detonation event propagating through the solid structure of the linear detonation wave diverter. The detonation event and/or detonation wave produce acoustic waves that may travel outside of the working fluid flow path and through the linear detonation wave diverter solid mass. These acoustic waves may have sufficient amplitude that upon interaction with the unreacted working fluid interface surfaces induce a sympathetic ignition of uncombusted working fluid (i.e., cause a secondary ignition), even if the working fluid flow path upstream is severed. One technique of deflecting and/or absorbing this acoustic wave energy is to place one or more voids or other acoustic wave dampening structures between the reacting working fluid outlet and the working fluid inlet of the linear detonation wave diverter. Another technique of minimizing acoustic wave amplitude in contact with uncombusted working fluid interface surfaces is to shape the working fluid inlet(s) of the linear detonation wave diverter in a manner that minimizes the component of acoustic wave momentum incident on an uncombusted working fluid interface surface within the linear detonation wave diverter. Still another technique of minimizing the acoustic wave amplitude incident on a uncombusted working fluid interface surface within the linear detonation wave diverter is to design the linear detonation wave diverter to minimize resonant modes that allow build-up/amplification of reflected waves in close proximity to uncombusted working fluid interface surfaces.

A fracturing operation 1125 fractures a burst element (e.g., a burst disk or burst area of a laminated foil structure) within the linear detonation wave diverter. The burst element is designed to fracture and fail in the presence of a detonation event due to extreme pressure and/or temperature. The fractured burst element allows the release of the primary detonation wave within minimal impact on the linear wave diverter structure. In one implementation, the burst element is aligned axially with the incoming detonation waves. A venting operation 1130 vents the detonation waves and hot combustion gasses out of the linear detonation wave diverter through the fractured and failed burst element. The venting operation 1130 occurs substantially axially with the propagation of the detonation waves through the linear detonation wave diverter. As a result, the detonation waves are not forced to substantially change direction, which reduces the forces on the linear detonation wave diverter that are not intended to fail.

An absorbing operation 1135 absorbs sufficient thermal energy from the reacting working fluid to prevent a secondary ignition of the working fluid. The absorbed thermal energy allows the linear detonation wave diverter to maintain a low enough temperature so that any surfaces in contact with unreacted working fluid are at a temperature below the working fluid's thermal ignition temperature. A quenching operation 1140 quenches any secondary working fluid ignition with a microfluidic media or a microfluidic laminated foil structure. The microfluidic media or foil structure has pores sized such that working fluid may pass through the media or foil structure without combustion flames also passing through the media or foil structure. Thus, the media or foil structure quenches any secondary detonation waves that may be initiated from the hot combustion gases in contact with unreacted working fluid.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A detonation wave diverter comprising:
an exothermically reactive working fluid outlet configured to permit a detonation wave to travel into the detonation wave diverter; and
a burst element aligned with the working fluid outlet and configured to fail in the presence of a detonation event and permit the detonation wave to travel out of the detonation wave diverter.

2. The detonation wave diverter of claim 1, further comprising:
a detonation outlet axially aligned with the working fluid outlet and the burst member and configured to vent the detonation wave out of the detonation wave diverter without igniting working fluid within a working fluid inlet of the detonation wave diverter.

3. The detonation wave diverter of claim 1, further comprising:
a porous element located between a working fluid inlet and the working fluid outlet and configured to permit the working fluid to flow downstream of the porous element and prevent combustion from the detonation event from propagating upstream of the porous element.

4. The detonation wave diverter of claim 3, wherein the burst element and the porous element are each formed in a microporous laminated foil structure.

5. The detonation wave diverter of claim 3, wherein the burst element is formed separately from the porous element.

6. The detonation wave diverter of claim 1, wherein the detonation event produces one or both of detonation waves and acoustic waves.

7. The detonation wave diverter of claim 1, further comprising:
an acoustic wave deflection void oriented between a working fluid inlet and the working fluid outlet that deflects acoustic wave energy of the detonation event away from the working fluid inlet.

8. The detonation wave diverter of claim 1, further comprising:
an acoustic wave dampening structure oriented between a working fluid inlet and the working fluid outlet that absorbs acoustic wave energy of the detonation event.

9. The detonation wave diverter of claim 1, wherein one or both of a pressure and a temperature generated by the detonation event causes the burst member to fail.

10. The detonation wave diverter of claim 1, configured to operate with an exothermically reactive working fluid with an energy density greater than 1 MJ/kg, a volumetric energy density greater than 100 J/cc, and a chemical reaction time less than 1 ms.

11. A detonation wave diverter comprising:
an exothermically reactive working fluid outlet configured to permit a detonation wave to travel into the detonation wave diverter; and
a laminated foil aligned with the working fluid outlet and configured to fail in the presence of a detonation event and permit the detonation wave to travel out of the detonation wave diverter, wherein the laminated foil further permits the working fluid to flow downstream of the laminated foil and prevents combustion from the detonation event from propagating upstream of the laminated foil.

12. The detonation wave diverter of claim 11, further comprising:
a detonation outlet axially aligned with the working fluid outlet and the laminated foil and configured to vent the detonation wave out of the detonation wave diverter without igniting working fluid within a working fluid inlet of the detonation wave diverter.

13. The detonation wave diverter of claim 11, wherein the detonation event produces one or both of detonation waves and acoustic waves.

14. The detonation wave diverter of claim 11, further comprising:
an acoustic wave deflection void oriented between a working fluid inlet and the working fluid outlet that deflects acoustic wave energy of the detonation event away from the working fluid inlet.

15. The detonation wave diverter of claim 11, further comprising:
an acoustic wave dampening structure oriented between a working fluid inlet and the working fluid outlet that absorbs acoustic wave energy of the detonation event.

16. The detonation wave diverter of claim 11, wherein one or both of a pressure and a temperature generated by the detonation event causes the laminated foil to fail.

17. The detonation wave diverter of claim 11, configured to operate with an exothermically reactive working fluid with an energy density greater than 1 MJ/kg, a volumetric energy density greater than 100 J/cc, and a chemical reaction time less than 1 ms.

18. A method comprising:
permitting a detonation wave to travel into a exothermically reactive working fluid outlet of a detonation wave diverter;
fracturing a burst element aligned with the working fluid outlet responsive to a detonation event; and
venting the detonation wave past the fractured a burst element and out of the detonation wave diverter.

19. The method of claim 18, further comprising:
permitting the working fluid to flow downstream of a porous element located between a working fluid inlet and the working fluid outlet of the detonation wave diverter; and
preventing combustion from the detonation event from propagating upstream of the porous element.

20. The method of claim 19, wherein the burst element and the porous element are each formed in a microporous laminated foil structure.

21. The method of claim 19, wherein the burst element is formed separately from the porous element.

22. The method of claim 18, wherein one or both of a pressure and a temperature generated by the detonation event causes the burst element to fail.

23. The method of claim 18, further comprising:
feeding an exothermically reactive working fluid with an energy density greater than 1 MJ/kg, a volumetric energy density greater than 100 J/cc, and a chemical reaction time less than 1 ms through the detonation wave diverter.
